(19) United States
(12) Patent Application Publication
(10) Pub. No.: US 2008/0288150 A1
(43) Pub. Date: Nov. 20, 2008

(54) Vehicle control apparatus

(75) Inventors: Akira Isogai, Anjo-shi (JP); Kazuma Hashimoto, Anjo-shi (JP); Masao Oooka, Gamagoori-shi (JP); Yosuke Ito, Kariya-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/152,205

(22) Filed: May 13, 2008

(30) Foreign Application Priority Data
May 14, 2007 (JP) 2007-128022

(51) Int. Cl. G06F 19/00

(52) U.S. Cl. 701/70

(57) ABSTRACT

The vehicle control apparatus includes a control section computing a command value indicative of acceleration/deceleration behavior to be taken by a vehicle, and an acceleration/deceleration controller controlling acceleration and deceleration of the vehicle by use of an acceleration/deceleration actuator on the basis of the command value. The acceleration/deceleration controller transmits driver-operated acceleration data indicative of an acceleration demand caused by operation by a driver of the vehicle, and the control section computing the command value at least according to the driver-operated acceleration data.

### CROSS-REFERENCE TO RELATED APPLICATION

This application is related to Japanese Patent Application No. 2007-128022 filed on May 14, 2007, the contents of which are hereby incorporated by reference.

### BACKGROUND OF THE INVENTION

1. Field of the Invention

The present invention relates to a vehicle control apparatus for controlling a vehicle by use of a plurality of drive support applications.

2. Description of Related Art

Generally, in an ACC (adaptive cruise control) system as a drive support application which includes a following-distance control section outputting a control value necessary to control a following distance, and an acceleration/deceleration control section driving an actuator in accordance with the control value, an acceleration value (a required acceleration) is used as interface data between the following-distance control section and the acceleration/deceleration control section. For example, refer to Japanese Patent No. 2911368.

Also, in a brake assist system as a drive support application which includes a risk judging section and a deceleration control section controlling a braking force depending on forward conditions detected by a radar and an operation amount of a brake by the driver of a vehicle, it is known to use a judging result (flag) as interface data between the risk judging section and the deceleration control section. For more details, refer to Japanese Patent Application Laid-open No. 11-048952. In a case where a plurality of drive support applications each of which includes a control-indicating section (such as the following-distance control section, and the risk judging section), and an acceleration/deceleration control section (or deceleration control section) are mounted on a vehicle, it is preferable that the control-indicating section and the acceleration/deceleration control section are separated from each other so that they operate independently from each other, and arbitration of the drive support applications is performed by the control-indicating section. In such a case, as interface data, an acceleration value used in the ACC system is appropriate.

However, in case the control-indicating section and the acceleration/deceleration control section are separated from each other as described above, there occurs a problem in versatility, because, for example, to perform brake assisting, the brake assist system is required to calculate a control value (required acceleration) to be outputted to the actuator on the basis of the driver's operating state with respect to acceleration/deceleration, which is obtained on the basis of sensor signals received from various sensors through a communication line, and also on the basis of the specification of a vehicle to be controlled.

That is, in case a plurality of drive support applications are included in a vehicle control apparatus, there arises problem that the vehicle control apparatus is low in versatility, because each of these applications has to compute and output the control value adjusted depending on the specification of a vehicle to be controlled.

### SUMMARY OF THE INVENTION

The present invention provides a vehicle control apparatus comprising:

a control section computing a command value indicative of acceleration/deceleration behavior to be taken by a vehicle; and

an acceleration/deceleration controller controlling acceleration and deceleration of the vehicle by use of an acceleration/deceleration actuator on the basis of the command value;

the acceleration/deceleration controller transmitting driver-operated acceleration data indicative of an acceleration demand caused by operation by a driver of the vehicle, the control section computing the command value at least according to the driver-operated acceleration data.

According to the present invention, it is possible to provide a vehicle control apparatus including a plurality of drive support applications, which is excellent in versatility.

Other advantages and features of the invention will become apparent from the following description including the drawings and claims.

### BRIEF DESCRIPTION OF THE DRAWINGS

In the accompanying drawings:

FIG. 1 is a diagram showing a system structure of a vehicle control apparatus according to an embodiment of the invention;

FIG. 2 is a diagram showing data exchanged between a drive support ECU and an acceleration/deceleration ECU included in the vehicle control apparatus;

FIG. 3 is a graph for explaining the term “Jerk” of acceleration;

FIG. 4 is a timing chart showing an example of the PCS control;

FIG. 5 is a flowchart showing the operation of the acceleration/deceleration ECU;

FIG. 6 is a flowchart showing the operation of the drive support ECU; and

FIG. 7 is a flowchart showing the operation of the acceleration/deceleration ECU.

### PREFERRED EMBODIMENTS OF THE INVENTION

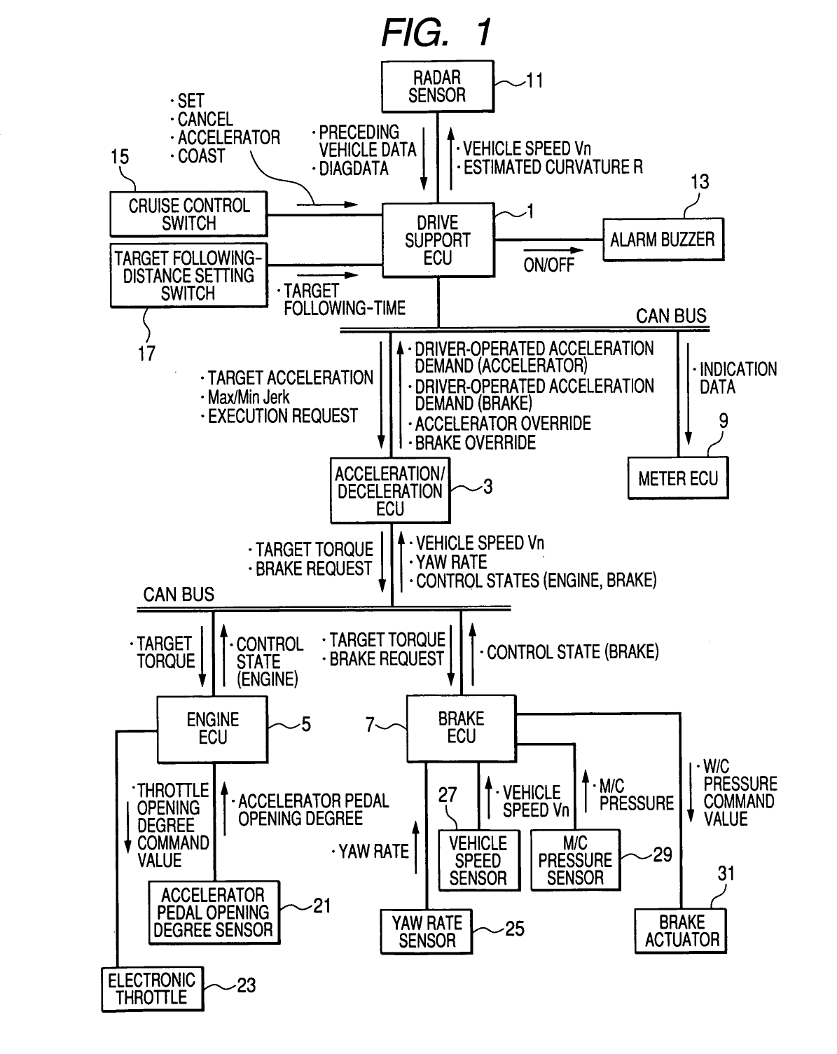

FIG. 1 is a diagram showing a system structure of a vehicle control apparatus of an embodiment of the invention. As shown in FIG. 1, this vehicle control apparatus includes an electronic control unit 1 for performing drive support control (referred to as “drive support ECU 1”), an electronic control unit 3 for performing acceleration/deceleration control (referred to as “acceleration/deceleration ECU 3”), an electronic control unit 5 for performing engine control (referred to as “engine ECU 5”), an electronic control unit 7 for performing brake control (referred to as “brake ECU 7”), and an electronic control unit 9 for performing meter control (referred to as “meter ECU 9”). These ECUs are connected to one another through a LAN communication bus.

Each of the ECUs 1 to 9, which is a microcomputer-based unit, includes a bus controller (not shown) used for performing communication with the outside through the LAN communication bus. As the LAN communication bus, a CAN bus commonly used for an in-vehicle network may be used.

The drive support ECU 1, which operates as a control center, and includes a plurality of drive support applications for performing ACC (adaptive cruise control), PCS (pre-crash safety) control, BA (brake assist) control, etc., is connected with a radar sensor 11, an alarm buzzer 13, a cruise control switch 15, a target following-distance setting switch 17.

The radar sensor 11 is a laser radar sensor constituted mainly by a laser-type scanning telemeter, and a microcomputer.

The radar sensor 11 is configured such that the scanning telemeter scan-illuminates a range of a predetermined angular width in the vehicle width direction with a laser beam, and the microcomputer computes an in-lane probability indicative of a probability that there is a target such as a preceding vehicle in the lane in which the vehicle on which the vehicle control apparatus is mounted (may be referred to as “instant vehicle” hereinafter) is running, and also computes attribute data of a target if any, on the basis of an angle and a distance to the target detected by the laser beam reflected from the target, a speed Vn of the instant vehicle received from the drive support ECU 1, and an estimated curvature radius R of the road on which the instant vehicle is running, etc. The radar sensor 11 transmits, as preceding vehicle data, the in-lane probability, attribute data, distance to the target, a relative speed with respect to the target, etc. to the drive support ECU 1. The radar sensor 11 also transmits a diagnostic signal of the radar sensor 11 to the drive support ECU 1.

From the cruse control switch 15 to the drive support ECU 1, there are transmitted a set signal to start the cruise control, a cancellation signal to cancel the cruise control, an acceleration signal to increase a set vehicle speed, a coast signal to decrease the set vehicle speed, etc.

The target following-distance setting switch 17 is a switch used for the driver to set the time needed for the instant vehicle to travel a target following-distance, or a target following time. This target following time is transmitted to the drive support ECU 1.

The drive support ECU 1 causes the alarm buzzer 13 to sound if the drive support ECU 1 determines it necessary. The meter ECU 9 receives data on the vehicle speed, engine speed, open/close states of the doors of the vehicle, shift range of the transmission, etc., through the LAN communication bus, and displays the received data on a not shown meter display. The meter ECU 9 also receives a flag indicative of the following-distance control being on, collision avoidance alarm, and diagnosis signal from the drive support ECU 1, and displays them on a not shown head-up display.

The engine ECU 5 is connected with an accelerator pedal opening degree sensor 21 for detecting an opening degree of the accelerator pedal, electronic throttle 23 which electrically drives a throttle. The engine ECU 5 receives a target torque from the acceleration/deceleration ECU 3, and the opening degree of the accelerator pedal from the accelerator pedal opening degree sensor 21. The engine ECU 5 transmits a control state of the engine to the acceleration/deceleration ECU 3. The engine ECU 5 computes a necessary throttle opening degree in accordance with the accelerator pedal opening degree, target torque, etc., and outputs the computed throttle opening degree command value to the electronic throttle 23 to control the engine.

The brake ECU 7 is connected with a yaw rate sensor 25 for detecting a yaw rate of the vehicle, a vehicle speed sensor 27 for detecting a speed of the vehicle, a brake pedal stepping-on force sensor (referred to as “M/C pressure sensor”) 29 for detecting a stepping-on force applied to the brake pedal from an M/C pressure (master cylinder pressure), and a brake actuator 31 for controlling a W/C pressure (wheel cylinder pressure) of a brake hydraulic pressure circuit to control a braking force.

The brake ECU 7 receives the target torque and a brake request (that is, a flag to request deceleration using the brake) from the acceleration/deceleration ECU 3, receives the yaw rate from the yaw rate sensor 25, receives the vehicle speed from the vehicle speed sensor 27, and receives the M/C pressure from the M/C pressure sensor 29. The brake ECU 7 transmits a braking control state to the acceleration/deceleration ECU 3, and outputs a W/C pressure command value to the brake actuator 31. In short, the brake ECU 7 computes a necessary W/C pressure in accordance with the yaw rate, vehicle speed, M/C pressure, target torque, and brake request, and outputs the computed necessary W/C pressure as the W/C pressure command value to the brake actuator 31.

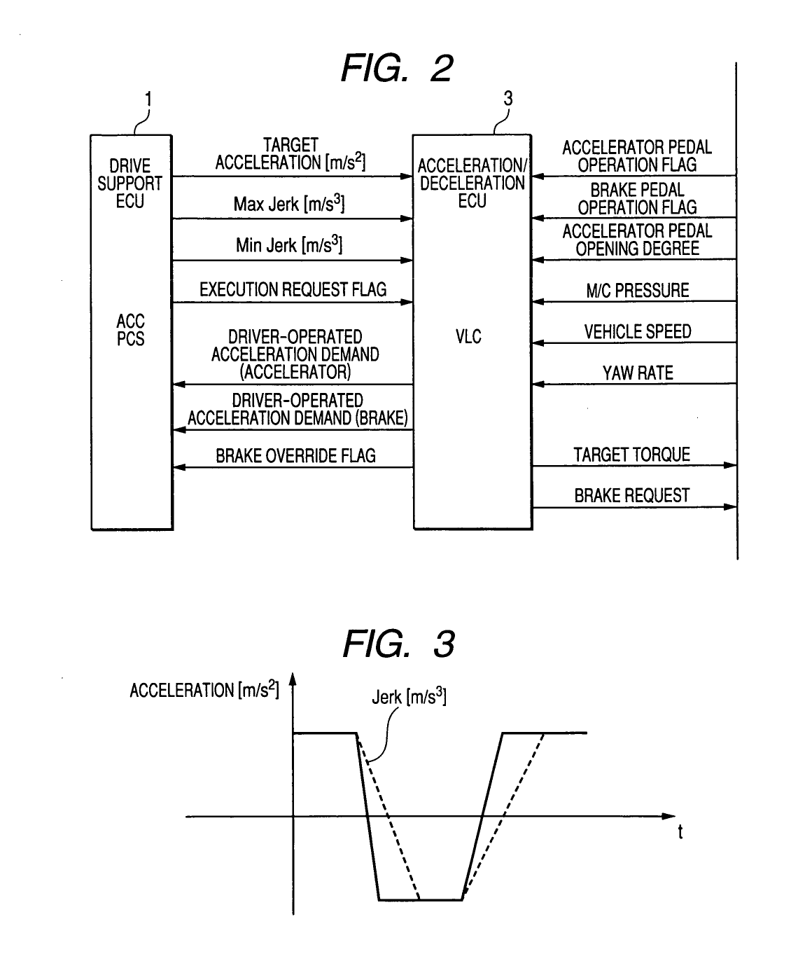

The acceleration/deceleration ECU 3, which operates as a acceleration/deceleration controller, includes an application for performing VLC (vehicle longitudinal control). As shown in FIG. 2, the acceleration/deceleration ECU 3 receives a requested acceleration (a target acceleration), an acceleration change rate (Max Jerk, Min Jerk), and an execution request flag from the drive support ECU 1, and transmits a driver-operated acceleration demand by the accelerator, a driver-operated acceleration demand by the brake pedal, an accelerator override flag, and a brake override flag to the drive support ECU 1.

Also, the acceleration/deceleration ECU 3 receives the control states of the brake and engine, vehicle speed, and yaw rate from the engine ECU 5 and the brake ECU 7, transmits the target torque to the engine ECU 5, and transmits the target torque and the brake request to the brake ECU 7.

In this embodiment, since the engine ECU 5 outputs, in response to the target torque, the throttle opening degree command value in accordance with which the electronic throttle 23 is driven, and the brake ECU 7 outputs, in response to the target torque and the brake request, the W/C pressure command value in accordance with which the brake actuator 31 is driven, the functions of the acceleration/deceleration ECU 3 may be included in the engine ECU 5, brake ECU 7, or drive support ECU 1.

In the following, the data exchanged between the acceleration/deceleration ECU 3 and the drive support ECU 7 is explained in more detail. The target acceleration is computed in the drive support application of the ACC or the PCS control. In some case, the target acceleration may be computed by different applications independently. In that case, one of a plurality of the computed different target accelerations is selected through arbitration among these applications in accordance with necessity (immediacy).

As shown in FIG. 3, the term “Jerk” indicates a rate at which the acceleration should be controlled to change. The terms “Max” and “MIN” respectively show a maximum value and a minimum value of Jerk.

The execution request flag is a flag commanding execution of the control in accordance with the transmitted target acceleration. The driver-operated acceleration demand means acceleration caused due to operation of the accelerator or the brake by the driver. When this acceleration is increased by the operation of the accelerator, it has a positive sign of (+). When this acceleration is decreased by the operation of the brake, it has a negative sign of (−). This driver-operated acceleration demand is used to implement a brake assist function and an alarm brake function (a function of applying a slight braking to inform the driver of the necessity of applying the brake) in the PCS control, or to detect the driver's operating state.

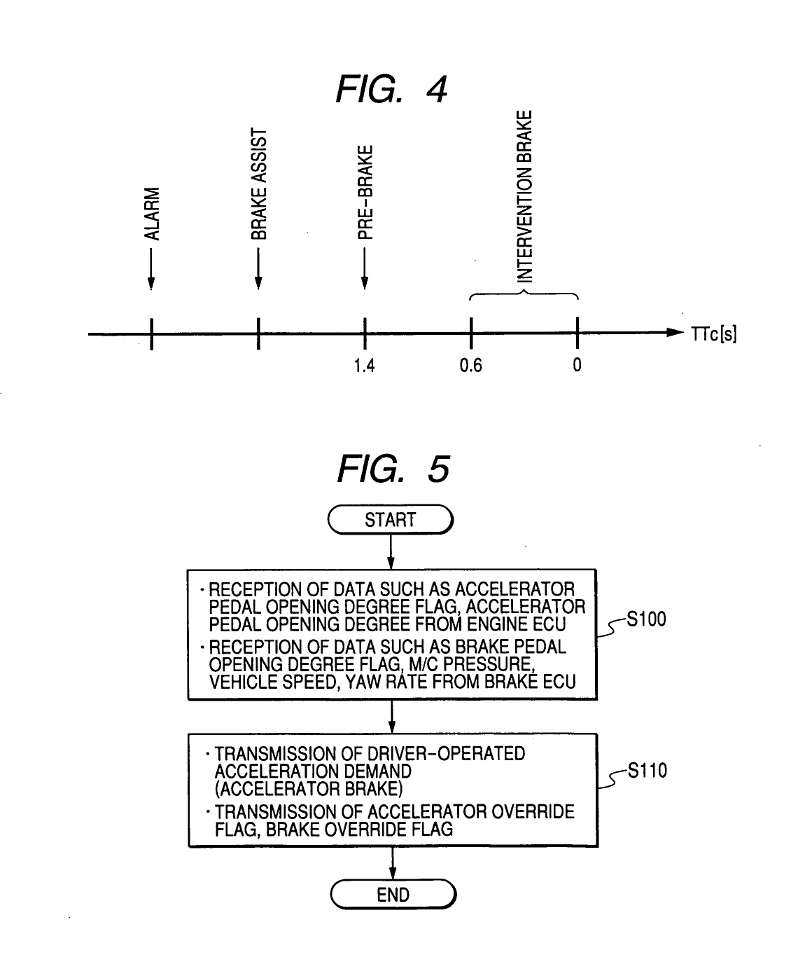

The accelerator override flag is used to detect which of the accelerator pedal operation by the driver and the target acceleration the drive support ECU 1 is using for its control operation. The brake override flag is used to detect which of the brake pedal operation by the driver and the target acceleration the drive support ECU 1 is using for its control operation. This brake override flag may be omitted. As shown in FIG. 4, the PCS control is such that an alarm operation, a brake assist operation, a pre-brake operation (slight braking), an intervention brake operation (strong braking) are performed at appropriate timings before the time (TTc=0) at which the vehicle may collide with an obstacle ahead of the vehicle.

Next, the operation of the vehicle control apparatus of this embodiment is explained. In this embodiment, the drive support ECU 1 includes a plurality of drive support applications.

To this drive support ECU 1, the driver-operated acceleration demand, and each override flag are transmitted from the acceleration/deceleration ECU 3. The drive support ECU 1 computes the target acceleration etc. used as control command values in each application on the basis of the driver-operated acceleration demand etc. received from the acceleration/deceleration ECU 3, and transmits the target acceleration, MAX Jerk, Min Jerk, execution request flag, etc. to the acceleration/deceleration ECU 3.

The acceleration/deceleration ECU 3 computes the target torque necessary to drive various actuators, brake request, etc. on the basis of the vehicle specification, for example, the specification of the hydraulic circuits, by use of the target acceleration transmitted from the drive support ECU 1, and also by use of the vehicle speed, yaw rate, and control states of the engine and brake transmitted from the engine ECU 5 and the brake ECU 7. The acceleration/deceleration ECU 3 transmits the computed target torque, brake request, etc to the engine ECU 5 and the brake ECU 7.

The engine ECU 5 transmits the throttle opening degree command value to the electronic throttle 23, and the brake ECU 7 transmits the W/C pressure command value to the brake actuator 31.

Next, the operations of the acceleration/deceleration ECU 3, and the drive support ECU 1 are explained taking the BA (brake assist) control included in the PCS control as an example with reference to the flowcharts shown in FIGS. 5 to 7.

### (1) The Operation of the Acceleration/Deceleration ECU 3.

As shown in FIG. 5, the acceleration/deceleration ECU 3 receives data such as an accelerator pedal opening degree flag, an accelerator pedal opening degree, etc from the engine ECU 5 at step S100. The acceleration/deceleration ECU 3 also receives data such as a brake pedal opening degree flag, the M/C pressure, vehicle speed, yaw rate, etc. from the brake ECU 7.

At following step S110, the acceleration/deceleration ECU 3 transmits the driver-operated acceleration demand, accelerator override flag, and brake override flag to the drive support ECU 1.

The driver-operated acceleration demand by the accelerator may be obtained from the accelerator pedal opening degree and the vehicle speed, while referring to a demand-drive-torque map in compliance with the engine model of the vehicle. The driver-operated acceleration demand by the brake may be obtained from the M/C pressure, while referring to a map in compliance with the actuator characteristic.

### (2) The Operation of the Drive Support ECU 1

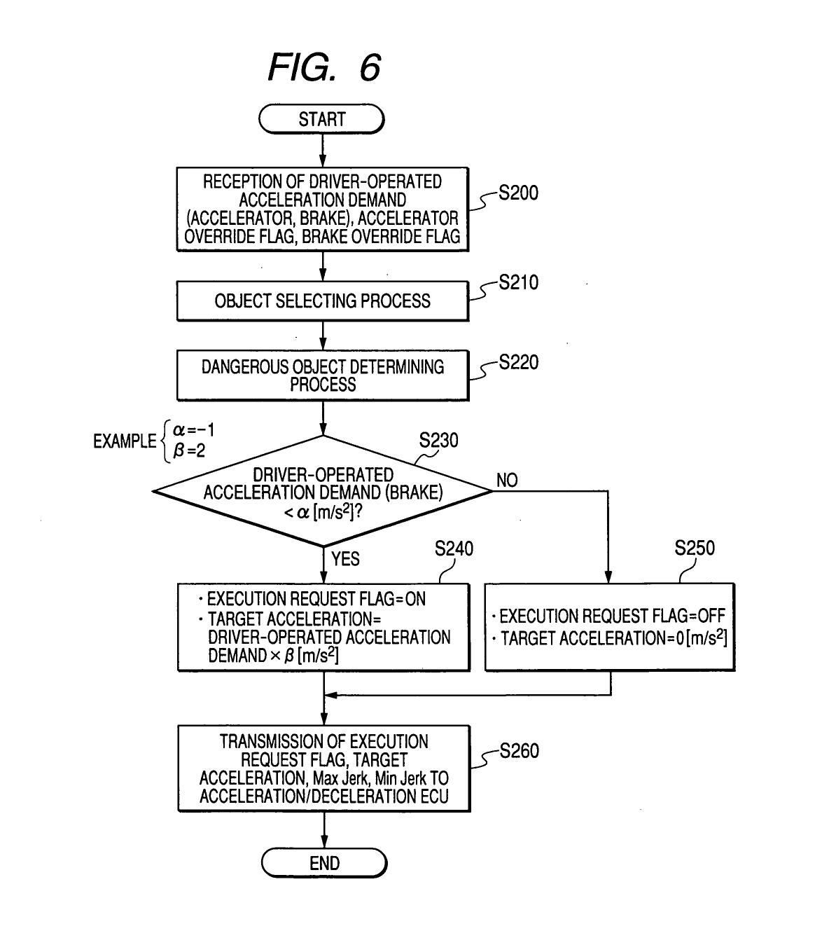

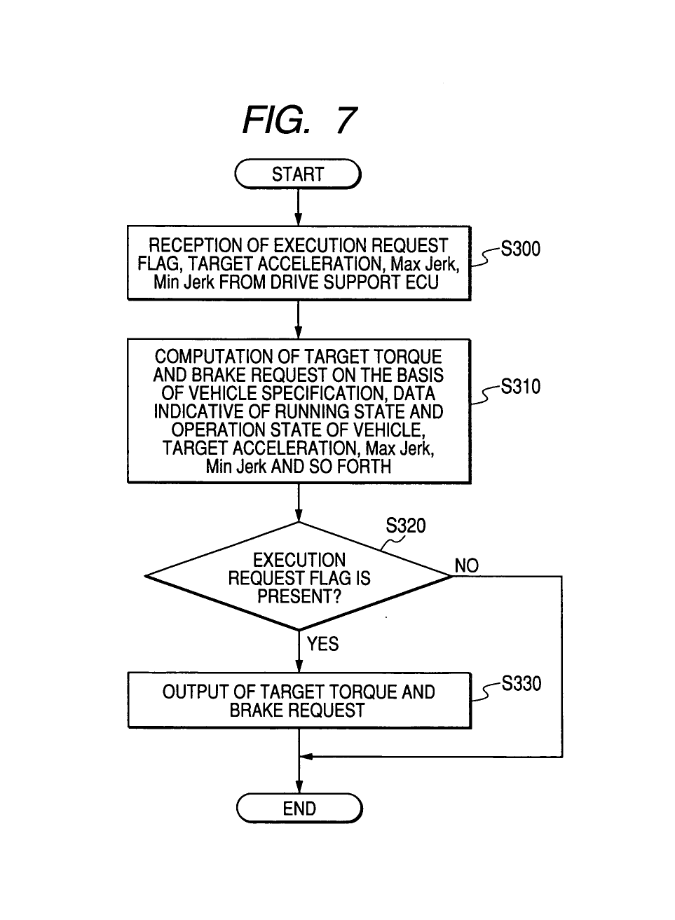

As shown in FIG. 6, the ECU 1 receives the driver-operated acceleration demand, accelerator overdrive flag, and brake override flag from the acceleration/deceleration ECU 3 at step S200.

At step S210, the drive support ECU 1 performs an object selecting process. This object selecting process is a process for determining which object should be selected to undergo the PCS control, for example. At step S220, the drive support ECU 1 performs a dangerous object determining process. This dangerous object determining process is a process for determining whether the selected object (a vehicle, for example) is a dangerous object with which the instant vehicle may collide on the basis of a distance to this object, the speed of the instant vehicle, etc.

At step S230, the drive support ECU 1 determines whether or not the driver-operate acceleration by the brake is smaller than a predetermined threshold value α, that is, whether or not the braking is insufficient.

If the determination result at step S230 is affirmative, since the brake assist control is necessary, the operation proceeds to step S240 where the execution request flag is turned on, and the target acceleration is set to the driver-operated acceleration demand multiplied by a predetermined value β.

On the other hand, if the determination result at step S230 is negative, since the brake assist control is not necessary, the operation proceeds to step S250 where the execution request flag is turned off, and the target acceleration is set to 0.

At step S260, the drive support ECU 1 transmit the execution request flag, target acceleration, Max Jerk, and Min Jerk to the acceleration/deceleration ECU 3, and then this operation is terminated.

### (3) The Operation of the Acceleration/Deceleration ECU 3

As shown in FIG. 7, the acceleration/deceleration ECU 3 receives the execution request flag, target acceleration, Max Jerk, and Min Jerk from the drive support ECU 1 at step S300.

At step S 310, the acceleration/deceleration ECU 3 computes the target torque and the brake request on the basis of the received execution request flag, target acceleration, Max Jerk, and Min Jerk, and also on the basis of the vehicle specification, and data indicative of the running state and the operation state of the vehicle.

At step S320, it is determined whether or not the execution request flag is present, that is, whether or not the execution request flag is on. If this determination result is affirmative, the acceleration/deceleration ECU 3 transmits the target torque to the engine ECU 5 and the brake ECU 7, and transmits the brake request to the brake ECU 7. After that, this operation is terminated.

As explained above, the vehicle control apparatus of this embodiment is configured such that the drive support ECU 1 computes the target acceleration etc. on the basis of data regarding operation on acceleration (driver-operated acceleration demand, for example) at the time of performing the drive support application, such as the PCS control, and the acceleration/deceleration ECU 3 outputs the command values such as the target torque and brake request which the acceleration/deceleration ECU 3 has computed on the basis of the target acceleration etc. received from the drive support ECU 1, and the vehicle specification.

The vehicle control apparatus of this embodiment is excellent in versatility, because even when it includes a plurality of drive support applications, necessary command values such as the target torque and the brake request in compliance with the engine model, etc. can be computed collectively at the side of the acceleration/deceleration ECU 3 depending on the target acceleration.

The above explained preferred embodiments are exemplary of the invention of the present application which is described solely by the claims appended below. It should be understood that modifications of the preferred embodiments may be made as would occur to one of skill in the art.

What is claimed is:

1. A vehicle control apparatus comprising:
a control section computing a command value indicative of acceleration/deceleration behavior to be taken by a vehicle; and
an acceleration/deceleration controller controlling acceleration and deceleration of said vehicle by use of an acceleration/deceleration actuator on the basis of said command value;
said acceleration/deceleration controller transmitting driver-operated acceleration data indicative of an acceleration demand caused by operation by a driver of said vehicle, said control section computing said command value at least according to said driver-operated acceleration data.

2. The vehicle control apparatus according to claim 1, wherein said driver-operated acceleration data is constituted of first data indicative of acceleration demand caused by an accelerator operation by said driver and second data indicative of an acceleration demand caused by a brake operation by said driver.

3. The vehicle control apparatus according to claim 1, wherein said control section and said acceleration/deceleration controller are interfaced by data on acceleration of said vehicle.

4. The vehicle control apparatus according to claim 3, wherein said control section transmits, as said command value, a requested acceleration to said acceleration/deceleration controller.

5. The vehicle control apparatus according to claim 4, wherein said control section includes a plurality of drive support applications each of which has a function of computing a target acceleration as said command value, arbitration of said drive support applications being performed in said control section to select one a plurality of target accelerations computed by said drive support applications as said requested acceleration.

6. The vehicle control apparatus according to claim 5, wherein said control section includes an ACC system and a PCS control system as said drive support applications.
